(19) United States
(12) Patent Application Publication
(10) Pub. No.: US 2026/0176109 A1
(43) Pub. Date: Jun. 25, 2026

(54) CRANE

(71) Applicant: SUMITOMO HEAVY INDUSTRIES, LTD., Tokyo (JP)

(72) Inventors: Yasuhiro YAMAMOTO, Kanagawa (JP); Chunnan WU, Kanagawa (JP); Keita NAKAMORI, Kanagawa (JP); Takatoshi ITO, Kanagawa (JP); Hisashi OSUMI, Tokyo (JP)

(21) Appl. No.: 19/421,547

(22) Filed: Dec. 16, 2025

(30) Foreign Application Priority Data
Dec. 24, 2024 (JP) 2024-227611

(51) Int. Cl. B66C 13/06; B66C 23/36

(52) U.S. Cl. CPC B66C 13/063; B66C 23/36; B66C 2700/0371

(57) ABSTRACT

A crane includes: an upper structure configured to be capable of slewing; an attachment provided on the upper structure configured to be capable of being luffed; a hook that is hung and configured to be capable of being raised and lowered via the attachment; and a controller including a memory and a processor coupled to the memory and configured to control a slew angular acceleration of the upper structure based on an angular acceleration waveform for suppressing sway of the hook in slew-stop control for automatically stopping slewing of the upper structure. The angular acceleration waveform includes a first period in which an angular acceleration decreases from zero at a constant first change rate, and a final period in which the angular acceleration increases to zero at a change rate opposite in sign to the first change rate after a predetermined period has elapsed after the first period.

### CROSS-REFERENCE TO RELATED APPLICATIONS

This application is based upon and claims priority to Japanese Patent Application No. 2024-227611, filed on Dec. 24, 2024, the entire contents of which are incorporated herein by reference.

### BACKGROUND

### 1. Technical Field

The present disclosure relates to a crane.

### 2. Description of Related Art

In the related art, a safety device that performs slew-stop control in a construction machine such as a crane is known. The safety device described in the related art calculates a required angle for braking and stopping the slewing without leaving sway of the suspended load, and a remaining angle through which the slewing can be performed until the suspended load reaches the rated load. The device then starts slew-braking based on a comparison between these angles.

### SUMMARY

A crane includes: an upper structure configured to be capable of slewing; an attachment provided on the upper structure configured to be capable of being luffed; a hook that is hung and configured to be capable of being raised and lowered via the attachment; and a controller including a memory and a processor coupled to the memory and configured to control a slew angular acceleration of the upper structure based on an angular acceleration waveform for suppressing sway of the hook in slew-stop control for automatically stopping slewing of the upper structure, in which the angular acceleration waveform includes a first period in which an angular acceleration decreases from zero at a constant first change rate, and a final period in which the angular acceleration increases to zero at a change rate after a predetermined period has elapsed after the first period, the change rate being opposite in sign to the first change rate.

### BRIEF DESCRIPTION OF THE DRAWINGS

FIG. 1 is a side view illustrating a crane according to an embodiment of the present disclosure;

FIG. 2 is a top view of an upper structure of the crane according to an embodiment of the present disclosure;

FIG. 3 is a side view illustrating the crane in a tower configuration according to an embodiment of the present disclosure;

FIG. 4 is a perspective view of an interior of an operator's compartment of the crane according to an embodiment of the present disclosure;

FIG. 5 is a block diagram of a hydraulic drive system of the crane according to an embodiment of the present disclosure;

FIG. 6 is a functional block diagram of the crane according to an embodiment of the present disclosure;

FIG. 7 is a flowchart illustrating example processing of the crane according to an embodiment of the present disclosure;

FIG. 8 is a diagram showing an example of an angular acceleration waveform of the crane according to an embodiment of the present disclosure;

FIG. 9 is a diagram showing an example of an angular acceleration waveform of the crane according to an embodiment of the present disclosure;

FIG. 10 is a diagram showing an example of an angular acceleration waveform of the crane according to an embodiment of the present disclosure;

FIG. 11 is a graph illustrating a stop time of sway of a suspended load and the maximum value of a sway angle according to a present embodiment;

FIG. 12 is a graph illustrating a comparison of angular acceleration waveforms between Example 1 and Comparative Example 1 according to the present disclosure;

FIG. 13 is a graph illustrating a comparison of angular acceleration waveforms between Example 2 and Comparative Example 2 according to the present disclosure; and

FIG. 14 is a diagram showing an example of sway of the suspended load of the crane according to an embodiment of the present disclosure.

### DETAILED DESCRIPTION

The safety device in the related art cannot start slew-braking when the required angle cannot be calculated.

The present disclosure provides a crane capable of suppressing sway of a suspended load upon stopping slewing.

Hereinafter, embodiments of a crane according to the present disclosure will be described with reference to the drawings.

The embodiments described below are intended to be illustrative and not restrictive of the invention. Not all features and combinations of the embodiments of the present disclosure are necessarily essential to the invention. The same or corresponding components are denoted by the same or corresponding reference signs throughout the drawings, and the redundant description thereof may be omitted.

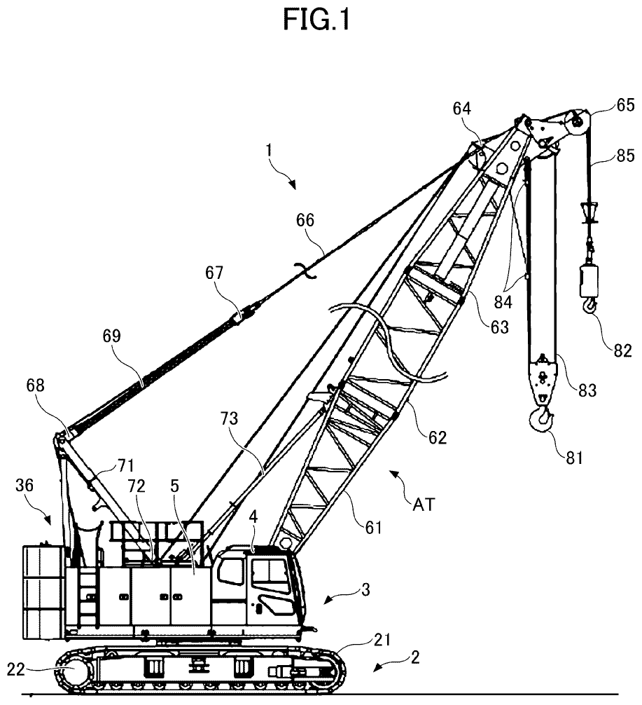

FIG. 1 is a side view illustrating a crane 1 according to an embodiment of the present disclosure. The crane 1 includes, for example, an undercarriage 2, an upper structure 3, and an attachment AT. The crane 1 illustrated in FIG. 1 is a mobile crane in a crane configuration and includes a lower boom 61, an intermediate boom 62, and an upper boom 63 as the attachment AT.

The undercarriage 2 includes, for example, left and right crawlers 21 and left-travel and right-travel devices 22. The crawlers 21 are driven by the travel devices 22 to rotate forward and rearward. The travel devices 22 are hydraulic actuators including hydraulic travel motors that are driven by hydraulic fluid under hydraulic pressure. By rotating the crawlers 21 forward or rearward, the crane 1 travels forward or rearward.

The upper structure 3 is provided on the undercarriage 2 so as to be capable of slewing. The upper structure 3 includes an operator's compartment 4 that is provided laterally to the attachment AT.

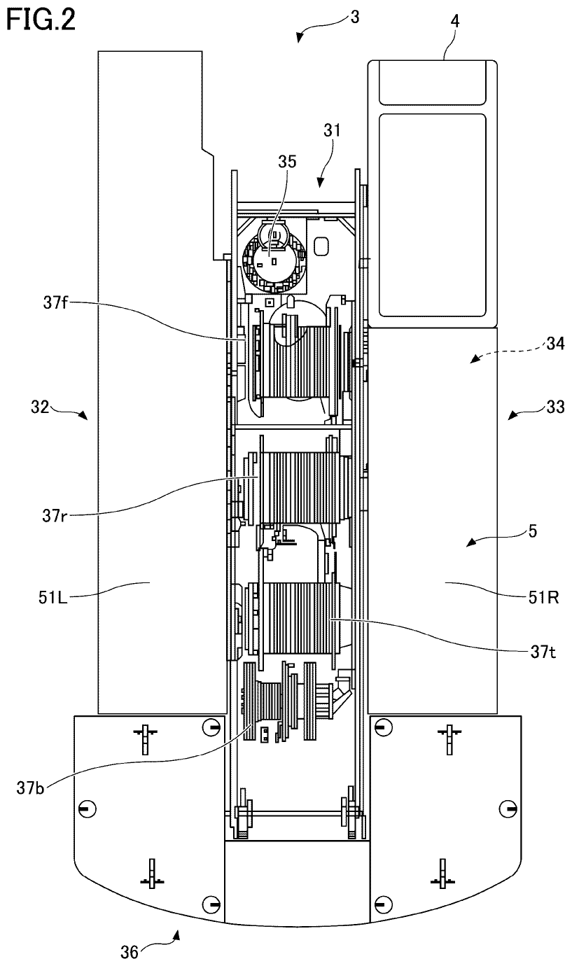

FIG. 2 is a top view of the upper structure 3 of the crane 1 illustrated in FIG. 1. Note that in FIG. 2, illustration of some components of the crane 1 illustrated in FIG. 1, including the attachment AT, is omitted. As illustrated in FIG. 2, the upper structure 3 includes, for example, an upper frame 31 and beds 32 and 33. Specifically, the upper structure 3 has the upper frame 31 that is provided on the undercarriage 2 so as to be capable of slewing, and the left and right beds 32 and 33 that are coupled to opposite sides of the upper frame 31.

A slew device 35 is provided at a front end of the upper frame 31, and a counterweight 36 is mounted at a rear end of the upper frame 31. The upper frame 31 is provided with, for example, a front winch 37f, a rear winch 37r, a third winch 37t, and a boom-luffing winch 37b. Note that the third winch 37t is optional in the crane 1.

The slew device 35 is, for example, a hydraulic actuator including a slew motor that is driven by hydraulic fluid under hydraulic pressure, and causes the upper frame 31, which is mounted on the undercarriage 2 so as to be capable of slewing, to slew relative to the undercarriage 2. The counterweight 36 may be, for example, a welded counterweight or a cast counterweight.

The front winch 37f, the rear winch 37r, the third winch 37t, and the boom-luffing winch 37b are, for example, hydraulic actuators including hydraulic motors that are driven by hydraulic fluid under hydraulic pressure. These winches wind a front-drum wire rope 83, a rear-drum wire rope 85, a boom-luffing wire rope 69, and the like illustrated in FIG. 1.

The left bed 32 is coupled to the left side of the upper frame 31 and is included in the left side of the upper structure 3. The right bed 33 is coupled to the right side of the upper frame 31 and is included in the right side of the upper structure 3. In an example illustrated in FIG. 2, the right bed 33 is located on the operator's compartment 4 side of the upper structure 3. The left and right beds 32 and 33 are provided with a house 5 that houses various kinds of devices mounted on the upper structure 3.

The house 5 has a removable left cover 51L that covers electrical devices and the like mounted on the left bed 32. The house 5 has a removable right cover 51R that covers various kinds of devices mounted on the right bed 33.

The operator's compartment 4 is provided, for example, at a front end of the right bed 33 and is located on the right side of the attachment AT. The operator's compartment 4 is also referred to as a cabin or a cab. Note that the operator's compartment 4 may be provided at a front end of the left bed 32 and located on the left side of the attachment AT.

The attachment AT is provided on the upper structure 3 so as to be capable of being luffed. Specifically, the attachment AT is attached to the front end of the upper frame 31, for example, via a boom foot pin disposed parallel to a width direction of the upper structure 3. In the crane 1 in a crane configuration as illustrated in FIG. 1, the attachment AT includes the lower boom 61, the intermediate boom 62, and the upper boom 63.

The lower boom 61 is mounted on the upper frame 31 of the upper structure 3 so as to be capable of pivoting forward and rearward with respect to the upper frame 31. The intermediate boom 62 is attached to a distal end of the lower boom 61. The upper boom 63 has a guide sheave 64 and an auxiliary sheave 65, and is attached to a distal end of the intermediate boom 62. The height of the attachment AT can be changed by increasing or decreasing the number of intermediate booms 62 arranged between the lower boom 61 and the upper boom 63.

Moreover, the crane 1 in a crane configuration as illustrated in FIG. 1 has a pendant rope 66, an upper spreader 67, a lower spreader 68, the boom-luffing wire rope 69, a gantry 71, a gantry raising/lowering cylinder 72, and a backstop 73.

One end of the pendant rope 66 is connected to a rear portion of the distal end of the upper boom 63, and the other end is connected to the upper spreader 67. The lower spreader 68 is attached to a distal end of the gantry 71, which is provided on the upper frame 31 so as to be capable of being raised and lowered. The gantry raising/lowering cylinder 72 is provided on the upper frame 31 in order to raise and lower the gantry 71. The boom-luffing wire rope 69 is reeved between the upper spreader 67 and the lower spreader 68, and is wound on the boom-luffing winch 37b.

With the gantry 71 erected by the gantry raising/lowering cylinder 72, the attachment AT can be pivoted rearward and upward into an erected position by winding the boom-luffing wire rope 69 with the boom-luffing winch 37b. In this case, rearward pivoting of the attachment AT is limited by the backstop 73. By unwinding the boom-luffing wire rope 69 with the boom-luffing winch 37b, the attachment AT can be pivoted forward and downward into a forward-tilted position.

Moreover, the crane 1 in a crane configuration as illustrated in FIG. 1 has a boom hook 81, a jib hook 82, the front-drum wire rope 83, an anti-two-block (ATB) device 84, and the rear-drum wire rope 85.

The front-drum wire rope 83 is reeved over the boom hook 81 and wound on the front winch 37f. The ATB device 84 is provided on the front-drum wire rope 83. The rear-drum wire rope 85 is connected to the jib hook 82 and wound on the rear winch 37r.

By winding the front-drum wire rope 83 with the front winch 37f, the boom hook 81 can be raised to hoist a suspended load. In this case, the ATB device 84 prevents excessive raising of the boom hook 81. By unwinding the front-drum wire rope 83 with the front winch 37f, the boom hook 81 can be lowered to lower the suspended load.

Similarly, by winding the rear-drum wire rope 85 with the rear winch 37r, the jib hook 82 can be raised to hoist the suspended load. By unwinding the rear-drum wire rope 85 with the rear winch 37r, the jib hook 82 can be lowered to lower the suspended load.

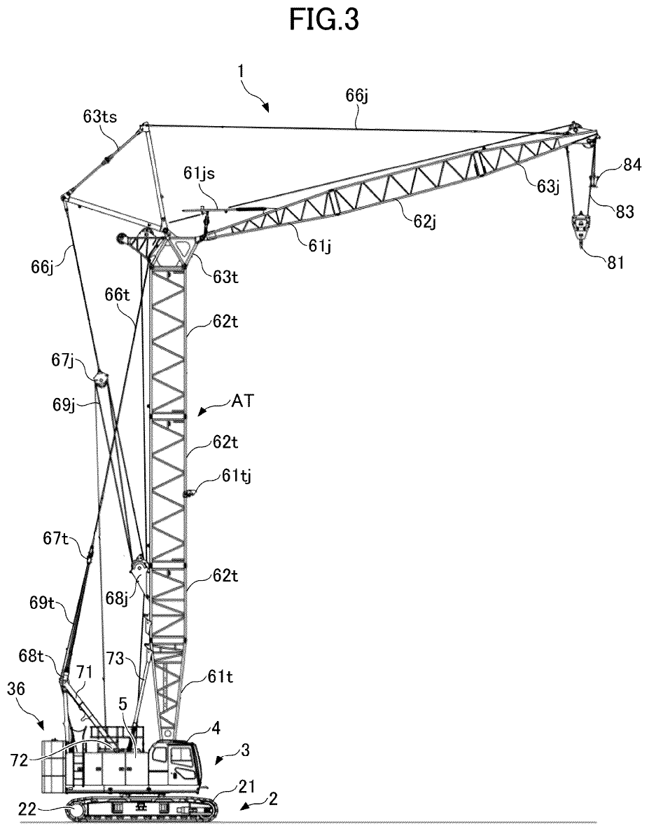

FIG. 3 is a side view illustrating the crane 1 of FIG. 1 in a tower configuration. In the crane 1 in a tower configuration, the attachment AT includes a lower tower boom 61t, an intermediate tower boom 62t, an upper tower boom 63t, a lower tower jib 61j, an intermediate tower jib 62j, and an upper tower jib 63j.

The lower tower boom 61t is mounted on the upper frame 31 of the upper structure 3 so as to be capable of pivoting forward and rearward with respect to the upper frame 31. The intermediate tower boom 62t is attached to a distal end of the lower tower boom 61t. The upper tower boom 63t has a tower strut 63ts and is attached to a distal end of the intermediate tower boom 62t. The height of the attachment AT can be changed by increasing or decreasing the number of intermediate tower booms 62t arranged between the lower tower boom 61t and the upper tower boom 63t.

The lower tower jib 61j has a tower-jib backstop 61js and is attached to the upper tower boom 63t so as to be capable of being luffed with respect to the upper tower boom 63t. The intermediate tower jib 62j is attached to a distal end of the lower tower jib 61j. The upper tower jib 63j is attached to a distal end of the intermediate tower jib 62j.

Moreover, the crane 1 in a tower configuration as illustrated in FIG. 3 has a tower-jib pendant rope 66j, an upper tower-jib spreader 67j, a lower tower-jib spreader 68j, and a tower-jib-luffing wire rope 69j.

The tower-jib pendant rope 66j is reeved between a distal end of the upper tower jib 63j and the tower strut 63ts, and further between the tower strut 63ts and the upper tower-jib spreader 67j. The lower tower-jib spreader 68j is attached to a rear portion of the intermediate tower boom 62t that is coupled to the distal end of the lower tower boom 61t. The tower-jib-luffing wire rope 69j is reeved between the upper tower-jib spreader 67j and the lower tower-jib spreader 68j, and is wound on a rear winch 37r.

By winding the tower-jib-luffing wire rope 69j with the rear winch 37r, a tower jib including the lower tower jib 61j, the intermediate tower jib 62j, and the upper tower jib 63j is pivoted rearward and upward into an erected position with respect to a tower boom including the lower tower boom 61t, the intermediate tower boom 62t, and the upper tower boom 63t. In this case, rearward pivoting of the tower jib is limited by the tower-jib backstop 61js. By unwinding the tower-jib-luffing wire rope 69j with the rear winch 37r, the tower jib is pivoted forward and downward.

Moreover, the crane 1 in a tower configuration as illustrated in FIG. 3 has a tower pendant rope 66t, an upper tower spreader 67t, a lower tower spreader 68t, and a tower-luffing wire rope 69t.

One end of the tower pendant rope 66t is connected to a rear portion of the upper tower boom 63t, and the other end is connected to the upper tower spreader 67t. The lower tower spreader 68t is attached to a distal end of the gantry 71, which is provided on the upper frame 31 so as to be capable of being raised and lowered. The tower-luffing wire rope 69t is reeved between the upper tower spreader 67t and the lower tower spreader 68t, and is wound on a boom-luffing winch 37b.

With the gantry 71 erected by a gantry raising/lowering cylinder 72, the attachment AT can be pivoted rearward and upward into an erected position by winding the tower-luffing wire rope 69t with the boom-luffing winch 37b. In this case, rearward pivoting of the attachment AT is restricted by a backstop 73. By unwinding the tower-luffing wire rope 69t with the boom-luffing winch 37b, the attachment AT can be pivoted forward and downward into a forward-tilted position.

Similar to the crane 1 in a crane configuration as illustrated in FIG. 1, the crane 1 in a tower configuration as illustrated in FIG. 3 has a boom hook 81, a front-drum wire rope 83, and an ATB device 84. Accordingly, by winding the front-drum wire rope 83 with the front winch 37f, the boom hook 81 can be raised to hoist a suspended load. In this case, the ATB device 84 prevents excessive raising of the boom hook 81. By unwinding the front-drum wire rope 83 with a front winch 37f, the boom hook 81 can be lowered to lower the suspended load.

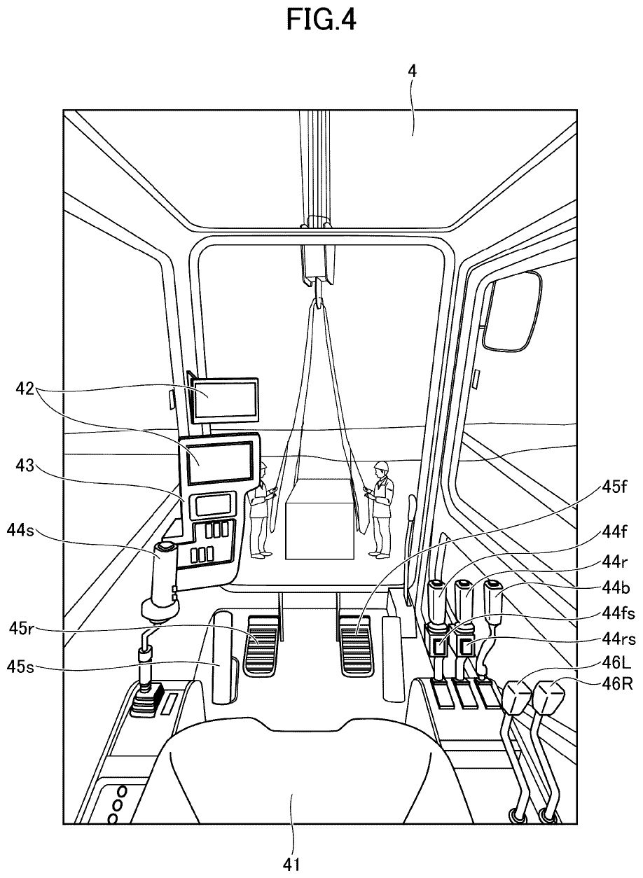

FIG. 4 is a perspective view of an interior of the operator's compartment 4 in the crane 1 illustrated in FIGS. 1 to 3. An operator's seat 41 on which the operator of the crane 1 sits is installed inside the operator's compartment 4. The longitudinal, lateral, and vertical directions of the crane 1 according to the present embodiment are, for example, the front-rear, left-right, and up-down directions as viewed by the operator sitting on the operator's seat 41. Various operating devices for operating the crane 1 are provided around the operator's seat 41.

Specifically, the operating devices of the crane 1 include, for example, a display device 42, a switch panel 43, a slew control lever 44s, a front-winch control lever 44f, a rear-winch control lever 44r, and a boom-luffing winch control lever 44b. The operating devices of the crane 1 further include, for example, a slew brake pedal 45s, a front-winch brake pedal 45f, a rear-winch brake pedal 45r, a left-travel control lever 46L, and a right-travel control lever 46R.

The display device 42 includes, for example, a touch panel, and displays an image of the surroundings of the crane 1 and displays information regarding overload prevention. The switch panel 43 receives various operations performed by the operator. The slew control lever 44s is used to slew the upper structure 3 with a slew device 35.

The front-winch control lever 44f is used to raise and lower the boom hook 81 with the front winch 37f. The rear-winch control lever 44r is used to raise and lower the jib hook 82 with the rear winch 37r and to luff the tower jib of the attachment AT in the tower configuration. The boom-luffing winch control lever 44b is used to luff the lower boom 61, the intermediate boom 62, and the upper boom 63, or to luff the lower tower boom 61t, the intermediate tower boom 62t, and the upper tower boom 63t.

The front-winch control lever 44f and the rear-winch control lever 44r may have a selector switch 44fs and a selector switch 44rs, respectively. The selector switch 44fs of the front-winch control lever 44f is used to switch the brake mode of the front winch 37f, and the selector switch 44rs of the rear-winch control lever 44r is used to switch the brake mode of the rear winch 37r.

The slew brake pedal 45s is used to apply braking to the upper structure 3 during slewing. The front-winch brake pedal 45f is used to apply rotational braking to the front winch 37f when the boom hook 81 is lowered with rotation of the front winch 37f being unlocked. The rear-winch brake pedal 45r is used to apply rotational braking to the rear winch 37r when the jib hook 82 is lowered with rotation of the rear winch 37r being unlocked. The left-travel control lever 46L is used to operate a left-travel device 22 included in the undercarriage 2. The right-travel control lever 46R is used to operate a right-travel device 22 included in the undercarriage 2.

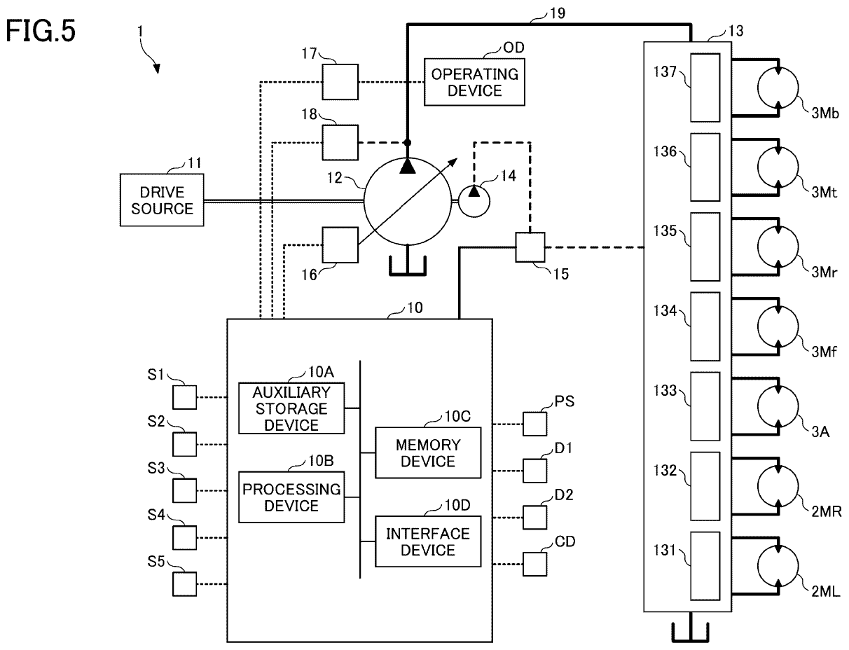

FIG. 5 is a block diagram of a hydraulic drive system and a control system of the crane 1 illustrated in FIGS. 1 to 4. In FIG. 5, a double line indicates transmission of mechanical power, and a solid line indicates a high-pressure hydraulic path. A broken line indicates a pilot-pressure transmission path, and a dotted line indicates a transmission path for electric and control signals.

The hydraulic drive system of the crane 1 includes hydraulic actuators to drive the undercarriage 2, the upper structure 3, the attachment AT, the boom hook 81, the jib hook 82, and the like. Specifically, the hydraulic actuators of the crane 1 include, for example, hydraulic motors such as a left-travel motor 2ML, a right-travel motor 2MR, a slew motor 3A, a front motor 3Mf, a rear motor 3Mr, a third motor 3Mt, and a boom-luffing motor 3Mb.

The left-travel motor 2ML is incorporated in the left-travel device 22 of the undercarriage 2 and generates power to rotate the left crawler 21 forward and rearward. The right-travel motor 2MR is incorporated in the right-travel device 22 of the undercarriage 2 and generates power to rotate the right crawler 21 forward and rearward. The slew motor 3A is incorporated in the slew device 35 illustrated in FIG. 2 and generates power to slew the upper structure 3 relative to the undercarriage 2.

The front motor 3Mf is incorporated in the front winch 37f illustrated in FIG. 2. The front motor 3Mf generates power to raise or lower the boom hook 81 by winding or unwinding the front-drum wire rope 83.

The rear motor 3Mr is incorporated in the rear winch 37r illustrated in FIG. 2. In the crane 1 in a crane configuration as illustrated in FIG. 1, the rear motor 3Mr generates power to raise or lower the jib hook 82 by winding or unwinding the rear-drum wire rope 85. In the crane 1 in a tower configuration as illustrated in FIG. 3, the rear motor 3Mr generates power to luff the attachment AT including the tower boom and the tower jib by winding or unwinding the tower-jib-luffing wire rope 69j.

The third motor 3Mt is incorporated in the third winch 37t illustrated in FIG. 2 and generates power to wind or unwind the wire rope wound on the third winch 37t.

The boom-luffing motor 3Mb is incorporated in the boom-luffing winch 37b illustrated in FIG. 2. The boom-luffing motor 3Mb generates power to luff the attachment AT including the lower boom 61, the intermediate boom 62, and the upper boom 63 by winding or unwinding the boom-luffing wire rope 69, as illustrated in the crane configuration of FIG. 1.

The hydraulic drive system of the crane 1 includes a drive source 11, a main pump 12, a control valve unit 13, a pilot pump 14, and a proportional control valve 15. The control system of the crane 1 includes a controller 10, a regulator 16, an operating device OD, an operation sensor 17, and a discharge-pressure sensor 18.

The drive source 11 is the main drive source in the hydraulic drive system, and is mounted, for example, at a rear portion of the upper structure 3. Specifically, the drive source 11 is rotated at a preset target rotational speed under direct or indirect control of the controller 10 to drive the main pump 12 and the pilot pump 14. The drive source 11 is, for example, an engine. Specifically, the drive source 11 is, for example, a diesel engine fueled by diesel. Note that the drive source 11 may be a gasoline engine, a hydrogen engine, or the like. The drive source 11 may be a combination of a power supply, such as a battery or a fuel cell, and an electric motor.

Similar to the drive source 11, the main pump 12 is mounted, for example, at the rear portion of the upper structure 3. The main pump 12 is a hydraulic pump configured to supply hydraulic fluid to the control valve unit 13 through a high-pressure hydraulic line 19. The main pump 12 is driven by the drive source 11 as described above. The main pump 12 is, for example, a variable displacement hydraulic pump. As described above, in the main pump 12, the stroke length of a piston may be adjusted by the regulator 16, which adjusts the tilt angle of a swash plate under the control of the controller 10 to control the discharge amount or the discharge pressure.

The control valve unit 13 is a hydraulic control device configured to control the hydraulic system in the crane 1. In the present embodiment, the control valve unit 13 includes control valves 131 to 137. The control valve unit 13 is configured to selectively supply hydraulic fluid discharged from the main pump 12 to one or more hydraulic actuators through the control valves 131 to 137.

The control valves 131 to 137 control the flow rate of hydraulic fluid flowing from the main pump 12 to the hydraulic actuators and the flow rate of hydraulic fluid flowing from corresponding hydraulic actuators to a hydraulic reservoir. More specifically, the control valves 131, 132, and 133 correspond to the left-travel motor 2ML, the right-travel motor 2MR, and the slew motor 3A, respectively. Moreover, the control valves 134, 135, 136, and 137 correspond to the front motor 3Mf, the rear motor 3Mr, the third motor 3Mt, and the boom-luffing motor 3Mb, respectively.

The pilot pump 14 is an example of a pilot-pressure generation device and is configured to supply hydraulic fluid to the hydraulic control devices via a pilot line. In the present embodiment, the pilot pump 14 is a fixed displacement hydraulic pump. Note that the pilot-pressure generation device may be implemented by the main pump 12. That is, the main pump 12 may have a function of supplying hydraulic fluid to various hydraulic control devices via the pilot line in addition to a function of supplying hydraulic fluid to the control valve unit 13 via a hydraulic line. In this case, the pilot pump 14 may be omitted.

The proportional control valve 15 functions as a control valve for machine control. The proportional control valve 15 is disposed in a conduit connecting the pilot pump 14 and the pilot ports of the control valves 131 to 137 in the control valve unit 13, and is configured to vary the flow-path area of the conduit. In the present embodiment, the proportional control valve 15 operates in accordance with a control command output from the controller 10. This enables the controller 10 to supply hydraulic fluid discharged from the pilot pump 14 to the pilot ports of the control valves 131 to 137 in the control valve unit 13 via the proportional control valve 15 independently of the operation of the operating device OD performed by the operator.

With this configuration, the controller 10 can operate a hydraulic actuator corresponding to a specific operating device OD even when the specific operating device OD is not operated. In a case where the crane 1 does not have a machine control function or a remote control function, the proportional control valve 15 is optional in the crane 1.

The regulator 16 controls the discharge amount of the main pump 12 serving as a hydraulic pump. In accordance with a control command from the controller 10, the regulator 16 adjusts the angle of the swash plate of the main pump 12, that is, the tilt angle, to control the displacement of the hydraulic fluid by the main pump 12 and then control the discharge amount of the hydraulic fluid by the main pump 12.

The operating device OD is a device used by the operator to operate the actuators. The operating device OD includes, for example, the slew control lever 44s, the front-winch control lever 44f, the rear-winch control lever 44r, and the boom-luffing winch control lever 44b, which are illustrated in FIG. 4. The operating device OD further includes, for example, the slew brake pedal 45s, the front-winch brake pedal 45f, the rear-winch brake pedal 45r, the left-travel control lever 46L, and the right-travel control lever 46R.

The operation sensor 17 is configured to detect the operations performed by the operator using the operating device OD. In the present embodiment, the operation sensor 17 detects the operation direction and the operation amount of the operating device OD corresponding to each of the actuators, and outputs the detected values to the controller 10.

The discharge-pressure sensor 18 is configured to detect a discharge pressure of the main pump 12. In the present embodiment, the discharge-pressure sensor 18 outputs, to the controller 10, a signal indicative of the detected discharge pressure of the main pump 12.

For example, the controller 10 is a control device provided in the operator's compartment 4 and configured to perform drive control of the crane 1. The controller 10 includes, for example, an auxiliary storage device 10A (e.g., a read-only memory (ROM)), a processing device 10B (e.g., a central processing unit (CPU)), a memory device 10C (e.g., a random access memory (RAM)), and an interface device 10D for communicating with different devices. The controller 10 is, for example, a controller configured to control various components of the crane 1. The controller 10 may be implemented as a single controller or a plurality of controllers.

The controller 10 controls an opening area of the proportional control valve 15 in accordance with an output of the operation sensor 17. Then, the controller 10 supplies the hydraulic fluid discharged from the pilot pump 14 to the pilot ports of the corresponding control valves 131 to 137 in the control valve unit 13. In principle, the pressure of the hydraulic fluid supplied to each pilot port (pilot pressure) corresponds to the operation direction and operation amount of the operation sensor 17 for the hydraulic actuator corresponding to the pilot port. As described above, the operating device OD is configured to supply the hydraulic fluid discharged from the pilot pump 14 to the pilot ports of the corresponding control valves 131 to 137 in the control valve unit 13.

Moreover, the control system of the crane 1 includes, for example, a slew sensor S1, a boom-luffing sensor S2, a tower-jib-luffing sensor S3, a length sensor S4, a sway sensor S5, a positioning device PS, a display device D1, an input device D2, and a communication device CD.

The slew sensor S1 outputs information on the slewing of the upper structure 3. The slew sensor S1 detects, for example, a slewing angular velocity and a slew angular acceleration of the upper structure 3 relative to the undercarriage 2. The slew sensor S1 also detects a slewing angle. Examples of the slew sensor S1 include, but are not limited to, a gyro sensor, a resolver, a rotary encoder, and an inertial measurement unit (IMU). A signal indicative of the slewing angle, the slewing angular velocity, the slew angular acceleration of the upper structure 3 detected by the slew sensor S1 is input to the controller 10.

The boom-luffing sensor S2 detects a luffing angle of the lower boom 61 or the lower tower boom 61t, that is, a tilt angle relative to the upper structure 3. The boom-luffing sensor S2 may be, for example, a gyro sensor, a resolver, a rotary encoder, or an IMU. A signal indicative of the luffing angle of the lower boom 61 or the lower tower boom 61t detected by the boom-luffing sensor S2 is input to the controller 10.

The tower-jib-luffing sensor S3 detects a luffing angle of the lower tower jib 61j, that is, a tilt angle of the lower tower jib 61j relative to the upper tower boom 63t. The tower-jib-luffing sensor S3 may be, for example, a gyro sensor, a resolver, a rotary encoder, or an IMU. A signal indicative of the luffing angle of the lower tower jib 61j detected by the tower-jib-luffing sensor S3 is input to the controller 10.

The length sensor S4 detects, for example, a length of a wire rope, such as the front-drum wire rope 83 or the rear-drum wire rope 85, hanging from the sheave at the distal end of the attachment AT. The length sensor S4 may be, for example, a gyro sensor, a resolver, a rotary encoder, or an IMU, each of which detects a rotation of the drum of the front winch 37f. Alternatively, the length sensor S4 may be, for example, a distance sensor configured to detect a distance from the sheave at the distal end of the attachment AT to a hook such as the boom hook 81 or the jib hook 82. A signal indicative of the length of the wire rope detected by the length sensor S4 is input to the controller 10.

The sway sensor S5 detects, for example, a sway angle and a corresponding sway angular velocity of a hook of the crane 1, such as the boom hook 81 or the jib hook 82. The sway sensor S5 may include, for example, a gyro sensor attached to the hook, or an image-capturing device attached to the distal end of the attachment AT. A signal indicative of the sway angle and the corresponding sway angular velocity of the hook detected by the sway sensor S5 is input to the controller 10.

The positioning device PS is configured to acquire information on a position of the crane 1. In the present embodiment, the positioning device PS is configured to measure a position and orientation of the crane 1. Specifically, the positioning device PS is a global navigation satellite system (GNSS) receiver incorporating an electronic compass, and measures the latitude, longitude, and altitude of the current position of the crane 1, as well as the orientation of the crane 1.

The display device D1 is provided in the operator's compartment 4 at a position easily viewable by the seated operator, and displays various informational images under the control of the controller 10. The display device D1 includes, for example, the display device 42 illustrated in FIG. 4. The display device D1 may be connected to the controller 10 via an on-vehicle communication network such as a controller area network (CAN), or may be connected to the controller 10 via a dedicated one-to-one line. The display device D1 is not limited to the display device 42 provided in advance in the operator's compartment 4, and may be a detachable monitor. The display device D1 may be, for example, a mobile information terminal such as a tablet personal computer (PC) capable of communicating with the communication device CD.

The input device D2 is provided within reach of the seated operator in the operator's compartment 4, receives various operation inputs from the operator, and outputs, to the controller 10, a signal indicative of each operation input. The input device D2 includes a touch panel and a knob switch. The touch panel is mounted on a display of the display device D1 that includes the display device 42 configured to display various informational images, and the knob switch is provided at the tip of a lever device such as the slew control lever 44s. The input device D2 also includes a button switch, a lever, a toggle, a rotary dial, and the like provided around the display device 42 installed in the operator's compartment 4. A signal indicative of the operation performed with the input device D2 is input to the controller 10.

The communication device CD communicates with an external device through a predetermined network including a mobile communication network, a satellite communication network, an Internet network, or the like. The communication device CD is, for example, a mobile communication module complying with mobile communication standards such as Long Term Evolution (LTE), 4th Generation (4G), or 5th Generation (5G), and/or a satellite communication module for connecting to a satellite communication network.

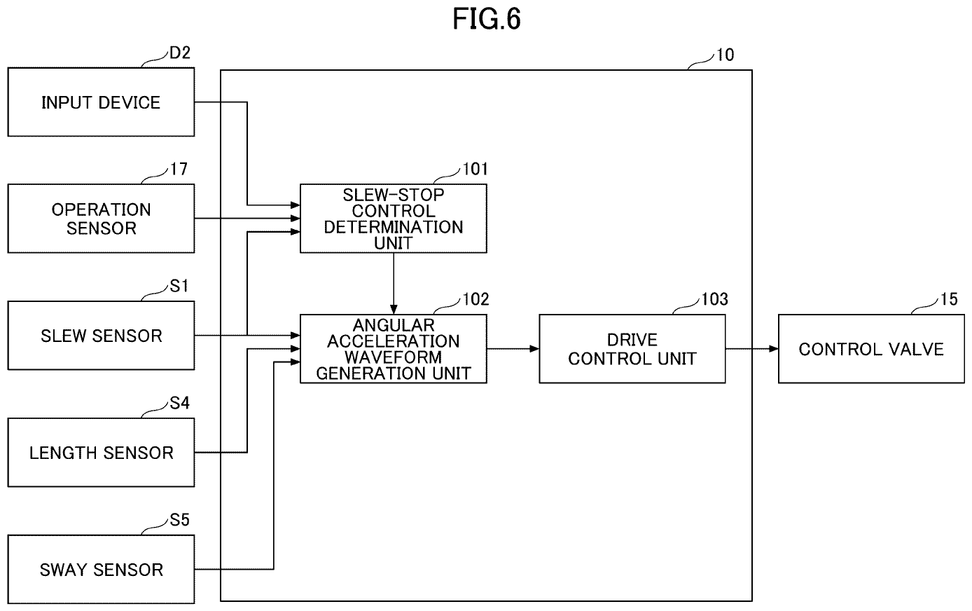

FIG. 6 is a functional block diagram of the controller 10 illustrated in FIG. 5. As illustrated in FIG. 6, the controller 10 includes, for example, a slew-stop control determination unit 101, an angular acceleration waveform generation unit 102, and a drive control unit 103. Each unit of the controller 10 represents, for example, each function of the controller 10 implemented by loading a program stored in the auxiliary storage device 10A onto the memory device 10C by the processing device 10B and executing the program. Note that each unit of the controller 10 illustrated in FIG. 6 may be implemented by a single controller or a plurality of different controllers.

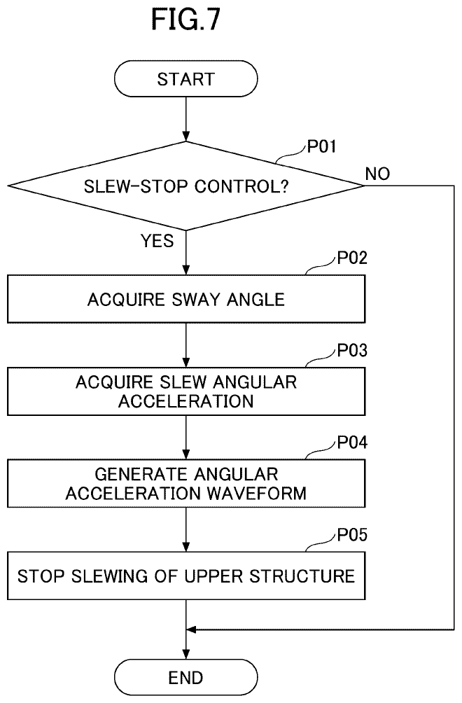

Hereinafter, the operation of each unit of the controller 10 will be described with reference to FIG. 7. FIG. 7 is a flowchart illustrating an example of the operation of the controller 10 in slew-stop control. For example, when an amount of slew operation of the slew control lever 44s operated by the operator of the crane 1 is input from the operation sensor 17, and a slew angular velocity or a slew angular acceleration of the upper structure 3 is input from the slew sensor S1, the controller 10 starts the processing flow illustrated in FIG. 7.

First, the controller 10 executes Processing P01 to determine whether to perform slew-stop control. In Processing P01, the slew-stop control determination unit 101 determines, for example, whether a condition for the slew-stop control is satisfied while the upper structure 3 is slewing. Specifically, the slew-stop control determination unit 101 determines that the slew-stop control is to be executed (YES), for example, when an emergency stop button included in the input device D2 is pressed by the operator of the crane 1 during slewing of the upper structure 3.

The slew-stop control determination unit 101 determines that the slew-stop control is to be executed (YES), for example, when it is detected that the operator of the crane 1 has suddenly released the slew control lever 44s of the operating device OD during slewing of the upper structure 3. The slew-stop control determination unit 101 detects that the operator of the crane 1 has suddenly released the slew control lever 44s, for example, based on the operation amount of the slew control lever 44s input from the operation sensor 17.

On the other hand, the slew-stop control determination unit 101 determines that the slew-stop control is not to be executed (NO), for example, when the emergency stop button is not pressed, and the operator of the crane 1 has not released the slew control lever 44s of the operating device OD. In this case, the controller 10 ends the processing flow illustrated in FIG. 7 and repeats Processing P01 in a predetermined cycle.

When the slew-stop control determination unit 101 determines that the slew-stop control is to be executed (YES) in Processing P01 as described above, the controller 10 executes Processing P02 to acquire a sway angle and executes Processing P03 to acquire a slew angular acceleration of the upper structure 3. The angular acceleration waveform generation unit 102 acquires a sway angle of the suspended load hooked to a hook, such as the boom hook 81 or the jib hook 82, from the sway sensor S5 in Processing P02, and acquires a slew angular velocity and a slew angular acceleration of the upper structure 3 from the slew sensor S1 in Processing P03.

Next, the controller 10 executes Processing P04 to generate an angular acceleration waveform for automatically stopping the upper structure 3 and executes Processing P05 to stop slewing of the upper structure 3 based on the angular acceleration waveform. In Processing P04, the angular acceleration waveform generation unit 102 generates an angular acceleration waveform with respect to the slew angle of the upper structure 3 for suppressing sway of a hook, such as the boom hook 81 or the jib hook 82, and outputs the angular acceleration waveform to the drive control unit 103. In Processing P05, the drive control unit 103 controls the slew angular acceleration of the upper structure 3 based on the angular acceleration waveform input from the angular acceleration waveform generation unit 102 to stop the slewing of the upper structure 3.

Specifically, the drive control unit 103 outputs, to the proportional control valve 15, a control command that is based on the angular acceleration waveform input from the angular acceleration waveform generation unit 102. The proportional control valve 15 controls the pilot pressure of the hydraulic fluid supplied from the pilot pump 14 to the control valve 133 of the control valve unit 13, based on the control command input from the drive control unit 103. As a result, the flow rate and direction of the hydraulic fluid supplied from the main pump 12 to the slew motor 3A via the control valve 133 are controlled.

Then, the slew angular velocity of the upper structure 3 is controlled by the slew motor 3A such that an angular acceleration in the slew direction at the sheave located at the distal end of the attachment AT changes in accordance with the angular acceleration waveform generated by the angular acceleration waveform generation unit 102. This automatically stops the slewing of the upper structure 3 while the sway of the suspended load, which is hooked to the hook hung from the sheave located at the distal end of the attachment A, is suppressed. Thereafter, the controller 10 ends the processing flow illustrated in FIG. 7.

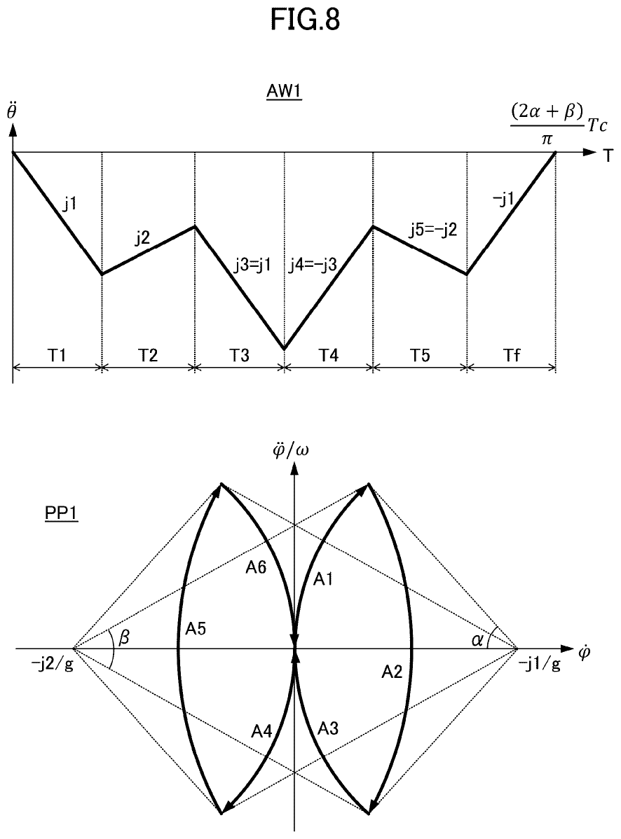

FIGS. 8 to 10 are diagrams illustrating examples of angular acceleration waveforms AW1, AW2, and AW3 generated by the angular acceleration waveform generation unit 102. The angular acceleration waveform generation unit 102 generates, for example, the angular acceleration waveforms AW1, AW2, and AW3, which are in the slew direction of the upper structure 3 and defined at the distal end of the attachment AT and serve as target control values of the slew-stop control. A wire rope for hanging a hook, such as the front-drum wire rope 83 for hanging the boom hook 81, is hooked to the sheave located at the distal end of the attachment AT. The suspended load is hooked to the hook hung from the sheave via the wire rope.

In FIGS. 8 to 10, the upper graphs illustrate the respective angular acceleration waveforms AW1, AW2, and AW3 of the slewing of the upper structure 3, with the vertical axis representing an angular acceleration d²θ/dt² [rad/s²], which is a second order time derivative of a slew angle θ [rad] of the upper structure 3, and the horizontal axis representing time T[s]. In FIGS. 8 to 10, the lower graphs illustrate respective phase planes PP1, PP2, and PP3, each showing the transition of a phase point corresponding to the sway angle φ of the suspended load in the slew direction of the upper structure 3.

The phase planes PP1, PP2, and PP3 correspond to the angular acceleration waveforms AW1, AW2, and AW3 in the drawings, respectively. In each of the phase planes PP1, PP2, and PP3, the horizontal axis represents an angular velocity dφ/dt [rad/s], which is a time derivative of the sway angle φ of the suspended load, and the vertical axis represents a value obtained by dividing an angular acceleration d²φ/dt² [rad/s²], which is a second order time derivative of the sway angle φ of the suspended load, by an angular frequency ω [rad/s] of the sway of the suspended load. Note that the angular frequency ω of the sway of the suspended load is expressed as ω=2π/Tc, where Tc is a cycle of the sway of the suspended load.

The angular acceleration waveforms AW1, AW2, and AW3 have a common feature in that each of them includes a first period T1 and a final period Tf. In the first period T1, the angular acceleration decreases from zero at a constant first change rate j1. In the final period Tf, the angular acceleration increases to zero at a change rate −j1, which is opposite in sign to the first change rate j1, after a predetermined period has elapsed after the first period T1.

The angular acceleration waveform AW1 illustrated in FIG. 8 includes a second period T2 and a third period T3. In the second period T2 continuous from the first period T1, the angular acceleration increases at a constant second change rate j2. In the third period T3 continuous from the second period T2, the angular acceleration decreases at a third change rate j3 equal to the first change rate j1. The angular acceleration waveform AW1 also includes a fourth period T4, a fifth period T5, and the final period Tf. In the fourth period T4 continuous from the third period T3, the angular acceleration increases at a constant fourth change rate j4 opposite in sign to the third change rate j3. In the fifth period T5 continuous from the fourth period T4, the angular acceleration decreases at a fifth change rate j5 opposite in sign to the second change rate j2. The final period Tf is continuous from the fifth period T5.

The magnitudes of the first change rate j1, the second change rate j2, and the like of the angular acceleration in the angular acceleration waveform AW1, and the durations of the periods T1 to Tf are determined based on a phase point corresponding to the sway angle φ of the suspended load in the phase plane PP1. Specifically, when the angular velocity and the angular acceleration with respect to the sway angle φ of the suspended load are zero during the slewing of the upper structure 3, the phase point corresponding to the sway angle φ of the suspended load is located at the origin of the phase plane PP1.

In this state, the slew-stop control is started, and the slew angular acceleration of the upper structure 3 is controlled such that the angular acceleration in the slew direction of the upper structure 3 and at the sheave located at the distal end of the attachment AT is decreased at the first change rate j1 as in the first period T1 of the angular acceleration waveform AW1. Then, the angular velocity and the angular acceleration with respect to the sway angle φ of the hook and the suspended load increase, and thus the phase point corresponding to the sway angle φ of the hook and the suspended load in the phase plane PP1 moves upward following an arc A1 centered on the point “−j1/g” on the horizontal axis. Note that “g” is the gravitational acceleration.

The slew angular acceleration of the upper structure 3 is further controlled such that the angular acceleration in the slew direction of the upper structure 3 and at the distal end of the attachment AT is increased at the second change rate j2 as in the second period T2 of the angular acceleration waveform AW1. Then, while the angular acceleration with respect to the sway angle φ of the suspended load decreases, the angular velocity changes from increasing to decreasing, and thus the phase point corresponding to the sway angle φ of the suspended load in the phase plane PP1 moves downward following an arc A2 centered on the point “−j2/g” on the horizontal axis.

The slew angular acceleration of the upper structure 3 is further controlled such that the angular acceleration in the slew direction of the upper structure 3 and at the distal end of the attachment AT is decreased at the third change rate j3, which is equal to the first change rate j1, as in the third period T3 of the angular acceleration waveform AW1. Then, the angular velocity decreases and the angular acceleration increases with respect to the sway angle φ of the hook and the suspended load, and thus the phase point corresponding to the sway angle φ of the hook and the suspended load in the phase plane PP1 moves upward to the origin following an arc A3 centered on the point “−j1/g” on the horizontal axis.

The slew angular acceleration of the upper structure 3 is further controlled such that the angular acceleration in the slew direction of the upper structure 3 and at the distal end of the attachment AT is increased at the fourth change rate j4, which is opposite in sign to the third change rate j3, as in the fourth period T4 of the angular acceleration waveform AW1. Then, the angular velocity and the angular acceleration with respect to the sway angle φ of the hook and the suspended load decrease, and thus the phase point corresponding to the sway angle φ of the hook and the suspended load in the phase plane PP1 moves downward following an arc A4 centered on the point “j1/g,” which is opposite in sign to “−j1/g” on the horizontal axis.

The slew angular acceleration of the upper structure 3 is further controlled such that the angular acceleration in the slew direction of the upper structure 3 and at the distal end of the attachment AT is decreased at the fifth change rate j5, which is opposite in sign to the second change rate j2, as in the fifth period T5 of the angular acceleration waveform AW1. Then, while the angular acceleration with respect to the sway angle φ of the hook and the suspended load increases, the angular velocity changes from increasing to decreasing, and thus the phase point corresponding to the sway angle φ of the hook and the suspended load in the phase plane PP1 moves upward following an arc A5 centered on the point “j2/g,” which is opposite in sign to “−j2/g” on the horizontal axis.

Finally, the slew angular acceleration of the upper structure 3 is further controlled such that the angular acceleration in the slew direction of the upper structure 3 and at the distal end of the attachment AT is increased at a change rate −j1, which is opposite in sign to the first change rate j1, as in the final period Tf of the angular acceleration waveform AW1. Then, while the angular velocity with respect to the sway angle φ of the hook and the suspended load increases, the angular acceleration decreases, and thus the phase point corresponding to the sway angle φ of the hook and the suspended load in the phase plane PP1 moves downward following an arc A6 centered on the point “j1/g” on the horizontal axis and stops at the origin. Accordingly, when the slewing of the upper structure 3 is stopped, the angular velocity and the angular acceleration with respect to the sway angle φ of the hook and the suspended load become zero, and the sway of the hook and the suspended load is suppressed.

In the angular acceleration waveform AW1 illustrated in FIG. 8, the time from the start of the first period T1 to the end of the final period Tf can be expressed as {(2α+β)/π} Tc using a central angle α of the arc A1 and a central angle β of the arc A2 in the phase plane PP1, and a sway cycle Tc of the suspended load. Therefore, by adjusting the central angle α of the arc A1 and the central angle β of the arc A2 in the phase plane PP1 to set (2α+β)/π to be 1 or less, the time from the start of the slew-stop control to the stopping of the slewing of the upper structure 3 and the sway of the hook and the suspended load can be made shorter than the sway cycle Tc. Thus, the sway of the hook and the suspended load can be stopped within one cycle or less.

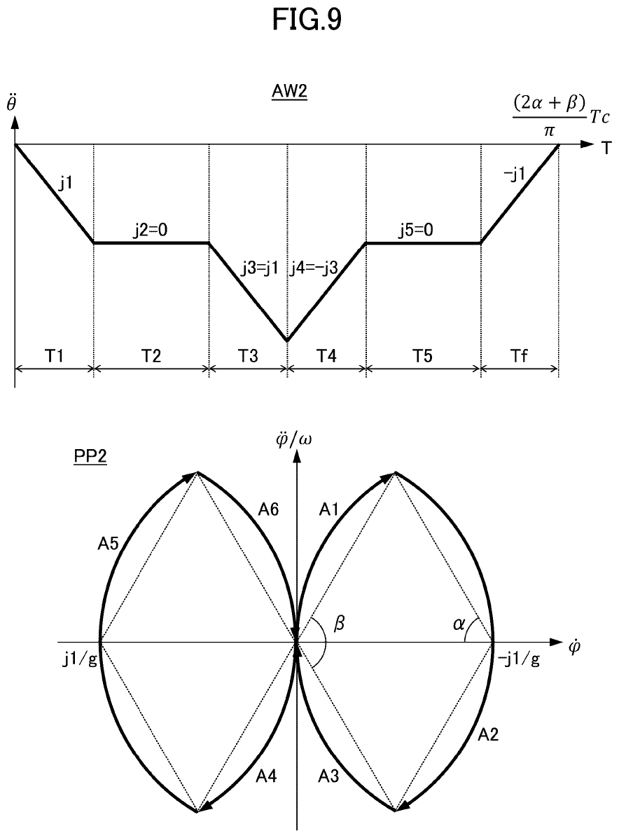

The angular acceleration waveform AW2 illustrated in FIG. 9 includes a second period T2 and a third period T3. In the second period T2 continuous from the first period T1, the angular acceleration remains constant with a change rate j2 of zero. In the third period T3 continuous from the second period T2, the angular acceleration decreases at a third change rate j3 equal to the first change rate j1. The angular acceleration waveform AW2 also includes a fourth period T4, a fifth period T5, and the final period Tf. In the fourth period T4 continuous from the third period T3, the angular acceleration increases at a constant fourth change rate j4 opposite in sign to the third change rate j3. In the fifth period T5 continuous from the fourth period T4, the angular acceleration remains constant with a change rate j5 of zero. The final period Tf is continuous from the fifth period T5.

The magnitudes of the first change rate j1 and the second change rate j2 of the angular acceleration in the angular acceleration waveform AW2, and the durations of the periods T1 to Tf are determined based on a phase point corresponding to the sway angle φ of the hook and the suspended load in the phase plane PP2. Specifically, when the angular velocity and the angular acceleration with respect to the sway angle φ of the hook and the suspended load are zero during the slewing of the upper structure 3, the phase point corresponding to the sway angle φ of the hook and the suspended load is located at the origin of the phase plane PP2.

In this state, the slew-stop control is started, and the slew angular acceleration of the upper structure 3 is controlled such that the angular acceleration in the slew direction of the upper structure 3 and at the sheave located at the distal end of the attachment AT is decreased at the first change rate j1 as in the first period T1 of the angular acceleration waveform AW2. Then, the angular velocity and the angular acceleration with respect to the sway angle φ of the hook and the suspended load increase, and thus the phase point corresponding to the sway angle φ of the hook and the suspended load in the phase plane PP2 moves upward following an arc A1 centered on the point “−j1/g” on the horizontal axis.

The slew angular acceleration of the upper structure 3 is further controlled such that the change rate j2 of the angular acceleration in the slew direction of the upper structure 3 and at the distal end of the attachment AT is maintained at zero as in the second period T2 of the angular acceleration waveform AW2. Then, while the angular acceleration with respect to the sway angle φ of the hook and the suspended load decreases, the angular velocity changes from increasing to decreasing, and thus the phase point corresponding to the sway angle φ of the hook and the suspended load in the phase plane PP2 moves downward following an arc A2 centered on the origin.

The slew angular acceleration of the upper structure 3 is further controlled such that the angular acceleration in the slew direction of the upper structure 3 and at the distal end of the attachment AT is decreased at the third change rate j3, which is equal to the first change rate j1, as in the third period T3 of the angular acceleration waveform AW2. Then, the angular velocity decreases and the angular acceleration increases with respect to the sway angle φ of the hook and the suspended load, and thus the phase point corresponding to the sway angle φ of the hook and the suspended load in the phase plane PP2 moves upward to the origin following an arc A3 centered on the point “−j1/g” on the horizontal axis.

The slew angular acceleration of the upper structure 3 is further controlled such that the angular acceleration in the slew direction of the upper structure 3 and at the distal end of the attachment AT is increased at the fourth change rate j4, which is opposite in sign to the third change rate j3, as in the fourth period T4 of the angular acceleration waveform AW2. Then, the angular velocity and the angular acceleration with respect to the sway angle φ of the hook and the suspended load decrease, and thus the phase point corresponding to the sway angle φ of the hook and the suspended load in the phase plane PP2 moves downward following an arc A4 centered on the point “j1/g,” which is opposite in sign to “−j1/g” on the horizontal axis.

The slew angular acceleration of the upper structure 3 is further controlled such that the change rate j5 of the angular acceleration in the slew direction of the upper structure 3 and at the distal end of the attachment AT is maintained at zero as in the fifth period T5 of the angular acceleration waveform AW2. Then, while the angular acceleration with respect to the sway angle φ of the hook and the suspended load increases, the angular velocity changes from increasing to decreasing, and thus the phase point corresponding to the sway angle φ of the hook and the suspended load in the phase plane PP2 moves upward following an arc A5 centered on the origin.

Finally, the slew angular acceleration of the upper structure 3 is further controlled such that the angular acceleration in the slew direction of the upper structure 3 and at the distal end of the attachment AT is increased at the change rate −j1, which is opposite in sign to the first change rate j1, as in the final period Tf of the angular acceleration waveform AW2. Then, while the angular velocity with respect to the sway angle φ of the hook and the suspended load increases, the angular acceleration decreases, and thus the phase point corresponding to the sway angle φ of the hook and the suspended load in the phase plane PP2 moves downward following an arc A6 centered on the point “j1/g” on the horizontal axis and stops at the origin. Accordingly, when the slewing of the upper structure 3 is stopped, the angular velocity and the angular acceleration with respect to the sway angle φ of the hook and the suspended load become zero, and the sway of the hook and the suspended load is suppressed.

In the angular acceleration waveform AW2 illustrated in FIG. 9, the time from the start of the first period T1 to the end of the final period Tf can be expressed as {(2α+β)/π} Tc using a central angle α of the arc A1 and a central angle β of the arc A2 in the phase plane PP2, and a sway cycle Tc of the hook and the suspended load. Therefore, by adjusting the central angle α of the arc A1 and the central angle β of the arc A2 in the phase plane PP2 to set (2α+β)/π to be 1 or less, the time from the start of the slew-stop control to the stopping of the slewing of the upper structure 3 and the sway of the hook and the suspended load can be made shorter than the sway cycle Tc. Thus, the sway of the hook and the suspended load can be stopped within one cycle or less.

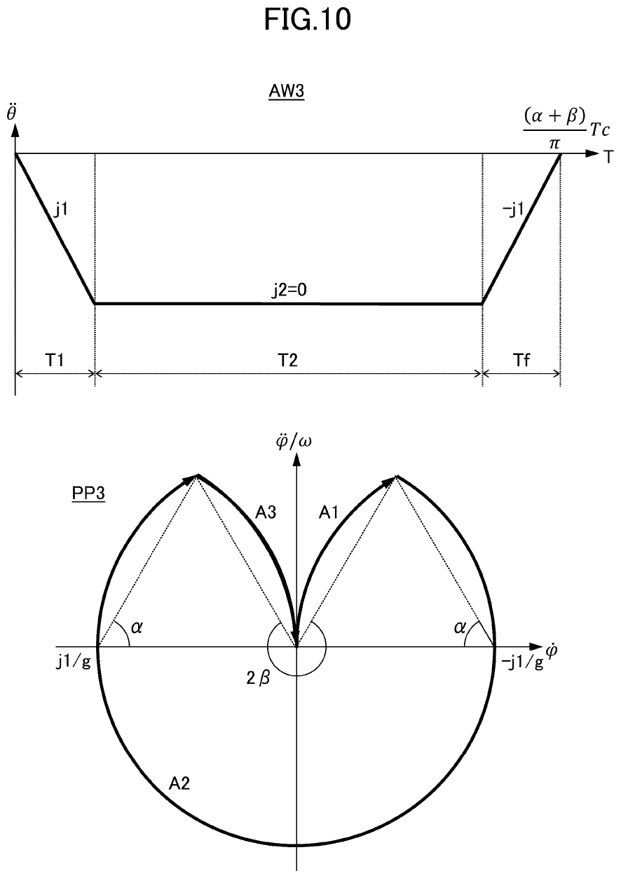

The angular acceleration waveform AW3 illustrated in FIG. 10 includes a second period T2 and the final period Tf. In the second period T2 continuous from the first period T1, the angular acceleration remains constant with a change rate j2 of zero. The final period Tf is continuous from the second period T2.

The magnitude of the first change rate j1 of the angular acceleration in the angular acceleration waveform AW3, and the durations of the periods T1 to Tf are determined based on a phase point corresponding to the sway angle φ of the hook and the suspended load in the phase plane PP3. Specifically, when the angular velocity and the angular acceleration with respect to the sway angle φ of the hook and the suspended load are zero during the slewing of the upper structure 3, the phase point corresponding to the sway angle φ of the hook and the suspended load is located at the origin of the phase plane PP3.

In this state, the slew-stop control is started, and the slew angular acceleration of the upper structure 3 is controlled such that the angular acceleration in the slew direction of the upper structure 3 and at the sheave located at the distal end of the attachment AT is decreased at the first change rate j1 as in the first period T1 of the angular acceleration waveform AW3. Then, the angular velocity and the angular acceleration with respect to the sway angle φ of the hook and the suspended load increase, and thus the phase point corresponding to the sway angle φ of the hook and the suspended load in the phase plane PP3 moves upward following an arc A1 centered on the point “−j1/g” on the horizontal axis.

The slew angular acceleration of the upper structure 3 is further controlled such that the change rate j2 of the angular acceleration in the slew direction of the upper structure 3 and at the distal end of the attachment AT is maintained at zero as in the second period T2 of the angular acceleration waveform AW3. Then, while the angular acceleration with respect to the sway angle φ of the hook and the suspended load decreases, the angular velocity changes from increasing to decreasing, and thus the phase point corresponding to the sway angle φ of the hook and the suspended load in the phase plane PP3 moves circularly following an arc A2 centered on the origin.

Finally, the slew angular acceleration of the upper structure 3 is further controlled such that the angular acceleration in the slew direction of the upper structure 3 and at the distal end of the attachment AT is increased at the change rate −j1, which is opposite in sign to the first change rate j1, as in the final period Tf of the angular acceleration waveform AW3. Then, while the angular velocity with respect to the sway angle φ of the hook and the suspended load increases, the angular acceleration decreases, and thus the phase point corresponding to the sway angle φ of the hook and the suspended load in the phase plane PP3 moves downward following an arc A3 centered on the point “j1/g,” which is opposite in sign to the point “−j1/g” on the horizontal axis, and stops at the origin. Accordingly, when the slewing of the upper structure 3 is stopped, the angular velocity and the angular acceleration with respect to the sway angle φ of the hook and the suspended load become zero, and the sway of the hook and the suspended load is suppressed.

In the angular acceleration waveform AW3 illustrated in FIG. 10, the time from the start of the first period T1 to the end of the final period Tf can be expressed as {(α+β)/π} Tc using a central angle α of the arc A1 and a central angle β of the arc A2 in the phase plane PP3, and a sway cycle Tc of the hook and the suspended load. Therefore, by adjusting the central angle α of the arc A1 and the central angle β of the arc A2 in the phase plane PP3 to set (α+β)/π to be close to 1, the time from the start of the slew-stop control to the stopping of the slewing of the upper structure 3 and the sway of the hook and the suspended load can be made even shorter.

As described above, in the examples illustrated in FIGS. 8 to 10, the controller 10 calculates the duration and the change rate for each period of the angular acceleration waveforms AW1, AW2, and AW3 by using the respective phase planes PP1, PP2, and PP3. The periods include the first period T1, the second period T2, and the like, and the change rates include the first change rate j1, the second change rate j2, and the like. The controller 10 calculates the duration and the change rate for each period such that the phase point of the suspended load and the hook starts from the origin and returns to the origin through the plurality of arcs based on the change rate for each period of the angular acceleration waveforms AW1, AW2, and AW3 in the respective phase planes PP1, PP2, and PP3. In each of the phase planes PP1, PP2, and PP3, the horizontal axis represents a time derivative value dφ/dt of the sway angle φ of the suspended load and the hook, and the vertical axis represents a value obtained by dividing a second order time derivative value d2φ/dt2 of the sway angle φ by an angular frequency ω of the sway of the suspended load and the hook.

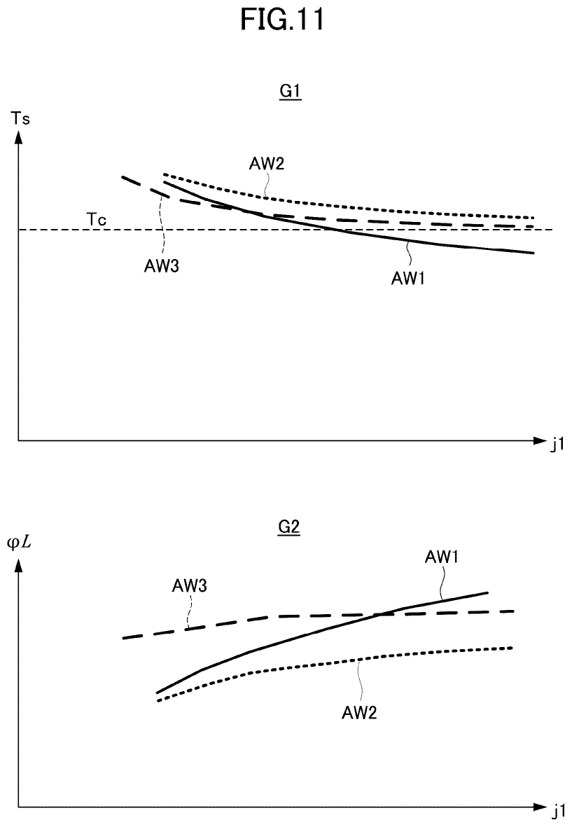

FIG. 11 is a diagram illustrating a comparison of the angular acceleration waveforms AW1, AW2, and AW3 in FIGS. 8 to 10. An upper graph G1 in FIG. 11 illustrates the relationship between the time Ts taken until the sway of the hook and the suspended load stops and the magnitude of the first change rate j1 of the angular acceleration waveform AW3. A lower graph G2 in FIG. 11 illustrates the relationship between the maximum value φL of the sway angle φ of the hook and the suspended load upon stopping slewing and the magnitude of the first change rate j1 of the angular acceleration waveform AW3.

As illustrated in the upper graph G1 in FIG. 11, the time Ts taken until the sway of the hook and the suspended load stops decreases by increasing the magnitude of the first change rate j1. In the angular acceleration waveform AW1, by increasing the magnitude of the first change rate j1, the sway of the suspended load can be stopped in a period shorter than the sway cycle Tc of the hook and the suspended load.

As illustrated in the lower graph G2 in FIG. 11, in the angular acceleration waveform AW1, the maximum value φL of the sway angle of the hook and the suspended load increases as the magnitude of the first change rate j1 is increased. In the angular acceleration waveform AW3, the maximum value φL of the sway angle of the suspended load eventually becomes smaller than the maximum value φL in the angular acceleration waveform AW1 as the magnitude of the first change rate j1 is increased. The angular acceleration waveform AW2 reduces the maximum value φL of the sway angle of the suspended load more effectively than the angular acceleration waveforms AW1 and AW3.

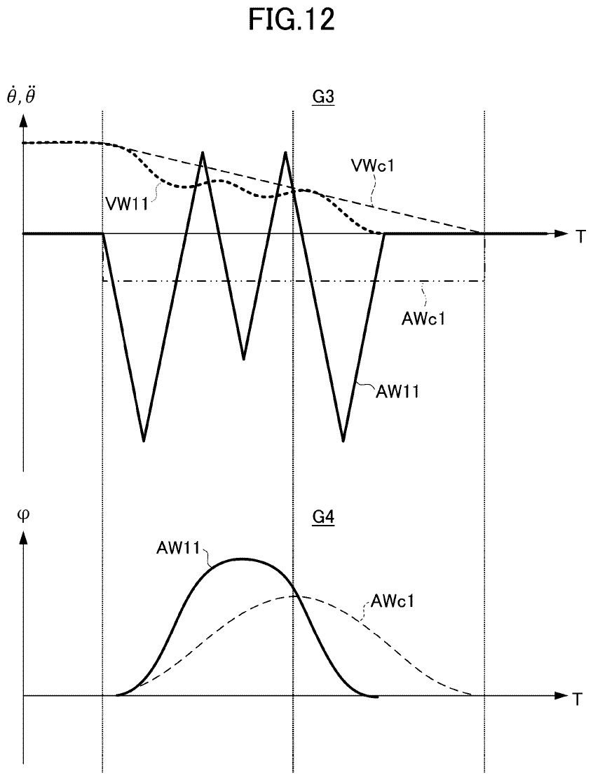

FIG. 12 is a diagram illustrating a comparison of an angular acceleration waveform AW11 of Example 1, which corresponds to the angular acceleration waveform AW1 in FIG. 8, and an angular acceleration waveform AWc1 of Comparative Example 1 in which the change rate of an angular acceleration is zero from the start to the end. An upper graph G3 in FIG. 12 illustrates the angular acceleration waveforms AW11 and AWc1 of Example 1 and Comparative Example 1 with the vertical axis representing angular acceleration, and also illustrates angular velocity waveforms VW11 and VWc1 of Example 1 and Comparative Example 1 with the vertical axis representing angular velocity. A lower graph G4 in FIG. 12 illustrates temporal changes in the sway angle φ of the suspended load corresponding to the angular acceleration waveforms AW11 and AWc1 of Example 1 and Comparative Example 1, with the vertical axis representing the sway angle φ of the suspended load and the horizontal axis representing time T.

In the upper graph G3 in FIG. 12, when the angular acceleration of the distal end of the attachment AT is controlled in accordance with the angular acceleration waveform AWc1 of Comparative Example 1 indicated by a thin two-dotted chain line, the angular velocity waveform VWc1 of the distal end of the attachment AT decreases at a constant change rate indicated by a thin broken line and becomes zero. On the other hand, in the upper graph G3 in FIG. 12, when the angular acceleration of the distal end of the attachment AT is controlled in accordance with the angular acceleration waveform AW11 of Example 1 indicated by a thick solid line, the angular velocity waveform VW11 of the distal end of the attachment AT decreases with the change rate repeatedly increasing and decreasing as indicated by a thick dotted line.

As a result, in the lower graph G4 in FIG. 12, the sway angle φ of the suspended load corresponding to the angular acceleration waveform AW11 of Example 1 indicated by the thick solid line becomes zero in a shorter time than the time taken for the sway angle φ of the suspended load corresponding to the angular acceleration waveform AWc1 of Comparative Example 1 indicated by the thin broken line to become zero. On the other hand, the maximum value of the sway angle φ of the suspended load corresponding to the angular acceleration waveform AW11 of Example 1 indicated by the thick solid line is slightly larger than the maximum value of the sway angle φ of the suspended load corresponding to the angular acceleration waveform AWc1 of Comparative Example 1 indicated by the thin broken line.

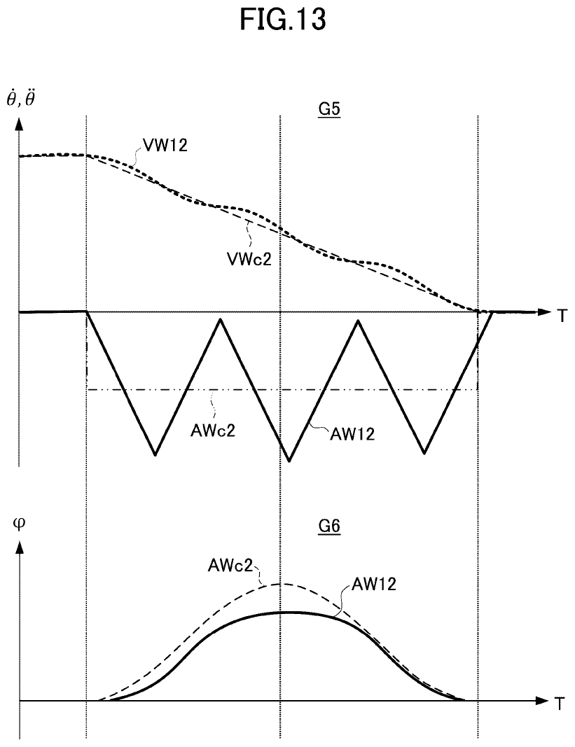

FIG. 13 is a diagram illustrating a comparison of an angular acceleration waveform AW12 of Example 2, which corresponds to the angular acceleration waveform AW1 in FIG. 8, and an angular acceleration waveform AWc2 of Comparative Example 2 in which the change rate for an angular acceleration is zero from the start to the end. An upper graph G5 in FIG. 13 illustrates the angular acceleration waveforms AW12 and AWc2 of Example 2 and Comparative Example 2 with the vertical axis representing angular acceleration, and also illustrates angular velocity waveforms VW12 and VWc2 of Example 2 and Comparative Example 2 with the vertical axis representing angular velocity. A lower graph G6 in FIG. 13 illustrates temporal changes in the sway angle φ of the suspended load corresponding to the angular acceleration waveforms AW12 and AWc2 of Example 2 and Comparative Example 2, with the vertical axis representing the sway angle φ of the suspended load and the horizontal axis representing time T.

In the upper graph G5 in FIG. 13, when the angular acceleration of the distal end of the attachment AT is controlled in accordance with the angular acceleration waveform AWc2 of Comparative Example 2 indicated by a thin two-dotted chain line, the angular velocity waveform VWc2 of the distal end of the attachment AT decreases at a constant change rate indicated by a thin broken line and becomes zero. On the other hand, in the upper graph G5 in FIG. 13, when the angular acceleration of the distal end of the attachment AT is controlled in accordance with the angular acceleration waveform AW12 of Example 2 indicated by a thick solid line, the angular velocity waveform VW12 of the distal end of the attachment AT decreases with the change rate repeatedly increasing and decreasing as indicated by a thick dotted line.

As a result, in the lower graph G6 in FIG. 13, the maximum value of the sway angle φ of the suspended load corresponding to the angular acceleration waveform AW12 of Example 2 indicated by the thick solid line becomes smaller than the maximum value of the sway angle φ of the suspended load corresponding to the angular acceleration waveform AWc2 of Comparative Example 2 indicated by the thin broken line. The time taken for the sway angle φ of the suspended load corresponding to the angular acceleration waveform AW12 of Example 2 indicated by the thick solid line to become zero is substantially the same as the time taken for the sway angle φ of the suspended load corresponding to the angular acceleration waveform AWc2 of Comparative Example 2 indicated by the thin broken line to become zero.

As described above, by adjusting the first change rate j1 and the second change rate j2, the angular acceleration waveforms AW11 and AW12 of Examples 1 and 2 can decrease the sway angle φ of the suspended load upon slew-stop control of the upper structure 3 and can shorten the time taken to stop the sway of the suspended load.

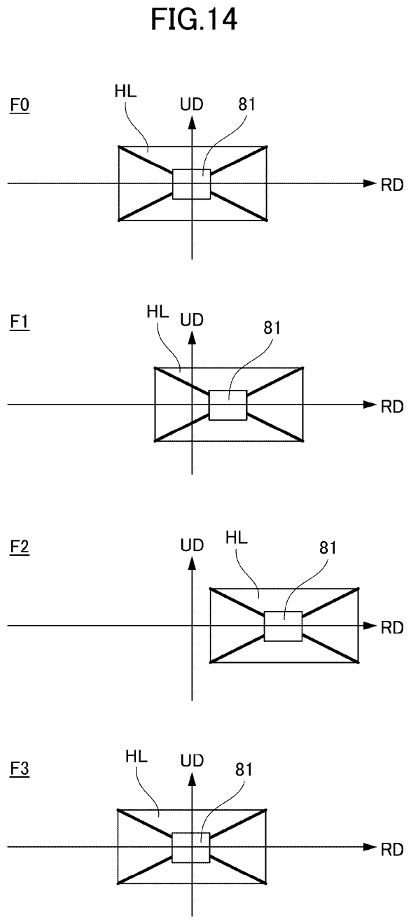

FIG. 14 is a diagram illustrating an example of the sway of a suspended load HL during slew-stop control. FIG. 14 is a plan view of the boom hook 81 and the suspended load HL. The boom hook 81 is hung from via the wire rope the sheave provided at the distal end of the attachment AT, and the suspended load HL is hooked to the boom hook 81. FIG. 14 illustrates a slew direction RD of the upper structure 3 and a luffing direction UD of the attachment AT.

As illustrated in an initial state F0 in FIG. 14, the controller 10 starts the slew-stop control while the sway angle φ, the angular velocity, and the angular acceleration of the suspended load HL in the slew direction RD are zero during the slewing of the upper structure 3. Then, the controller 10 controls the slewing of the upper structure 3 such that the angular acceleration of the distal end of the attachment AT follows the angular acceleration waveforms AW1, AW2, or AW3, which suppress the sway of the suspended load HL.

Then, as illustrated in FIG. 14, the sway angle φ of the suspended load HL increases at a first stage F1, and the sway angle φ of the suspended load HL reaches a maximum at a second stage F2. Thereafter, the sway angle φ of the suspended load HL decreases, and at a third stage F3, the sway of the suspended load HL stops or the sway of the suspended load HL is suppressed more effectively than in the related art, simultaneously with the stopping of the slewing of the upper structure 3.

The effects of the crane 1 according to the present embodiment will be described below.

As described above, the crane 1 of the present embodiment includes the upper structure 3 that is configured to be capable of slewing, the attachment AT which is provided to the upper structure 3 so as to be capable of being luffed, and a hook such as the boom hook 81 which is hung so as to be capable of being raised and lowered via the attachment AT. The crane 1 further includes the controller 10 configured to control the slew angular acceleration of the upper structure 3 based on the angular acceleration waveforms AW1, AW2, and AW3 for suppressing the sway of the hook in the slew-stop control for automatically stopping the slewing of the upper structure 3. The angular acceleration waveforms AW1, AW2, and AW3 each include the first period T1 and the final period Tf. In the first period T1, the angular acceleration decreases from zero at the constant first change rate j1. In the final period Tf, the angular acceleration increases to zero at a change rate −j1, which is opposite in sign to the first change rate j1, after a predetermined period has elapsed after the first period T1.

With this configuration, according to the crane 1 of the present embodiment, the controller 10 can control the slew angular velocity of the upper structure 3 in the slew-stop control of the upper structure 3 based on the angular acceleration waveforms AW1, AW2, and AW3 for suppressing the sway of the hook. Therefore, according to the present embodiment, the crane 1 capable of suppressing sway of a suspended load upon stopping slewing can be provided.

In the crane 1 of the present embodiment, the angular acceleration waveform AW1 includes the second period T2 and the third period T3. In the second period T2 continuous from the first period T1, the angular acceleration increases at the constant second change rate j2. In the third period T3 continuous from the second period T2, the angular acceleration decreases at the third change rate j3 equal to the first change rate j1. The angular acceleration waveform AW1 also includes the fourth period T4, the fifth period T5, and the final period Tf. In the fourth period T4 continuous from the third period T3, the angular acceleration increases at the fourth change rate j4 opposite in sign to the third change rate j3. In the fifth period T5 continuous from the fourth period T4, the angular acceleration decreases at the fifth change rate j5 opposite in sign to the second change rate j2. The final period Tf is continuous from the fifth period T5.

With this configuration, the crane 1 can reduce the time Ts taken until the sway of the hook, such as the boom hook 81, or the suspended load hooked to the hook is stopped, as compared with the case where other angular acceleration waveforms, such as the angular acceleration waveforms AW2 and AW3, are used upon the slew-stop control of the upper structure 3.

In the crane 1 of the present embodiment, the angular acceleration waveform AW2 includes the second period T2 and the third period T3. In the second period T2 continuous from the first period T1, the angular acceleration remains constant with the second change rate j2 of zero. In the third period T3 continuous from the second period T2, the angular acceleration decreases at the third change rate j3 equal to the first change rate j1. The angular acceleration waveform AW2 also includes the fourth period T4, the fifth period T5, and the final period Tf. In the fourth period T4 continuous from the third period T3, the angular acceleration increases at the fourth change rate j4 opposite in sign to the third change rate j3. In the fifth period T5 continuous from the fourth period T4, the angular acceleration remains constant with the fifth change rate j5 of zero. The final period Tf is continuous from the fifth period T5.

With this configuration, the crane 1 can reduce the maximum value φL of the sway angle of the hook, such as the boom hook 81, or the suspended load hooked to the hook, as compared with the case where other angular acceleration waveforms, such as the angular acceleration waveforms AW1 and AW3, are used upon the slew-stop control of the upper structure 3.

In the crane 1 of the present embodiment, the angular acceleration waveform AW3 includes the second period T2 and the final period Tf. In the second period T2 continuous from the first period T1, the angular acceleration remains constant with the change rate j2 of zero. The final period Tf is continuous from the second period T2.

With this configuration, the crane 1 can reduce the time Ts for stopping the sway of the suspended load and the maximum value φL of the sway angle with a simpler waveform, as compared with the case where other angular acceleration waveforms, such as the angular acceleration waveforms AW1 and AW2, are used upon the slew-stop control of the upper structure 3.

In the crane 1 of the present embodiment, the controller 10 uses the phase planes PP1, PP2, and PP3, in which the horizontal axis represents a time derivative value dφ/dt of the sway angle φ of the hook, and the vertical axis represents a value obtained by dividing a second order time derivative value d²φ/dt2 of the sway angle φ by an angular frequency ω of the sway of the hook. The controller 10 calculates the duration and the change rate for each period such that the phase point of the hook starts from the origin and returns to the origin through the plurality of arcs based on the change rate for each period of the angular acceleration waveforms AW1, AW2, and AW3 in the phase planes PP1, PP2, and PP3.

With this configuration, the crane 1 can control the slew angular velocity of the upper structure 3 upon the slew-stop control of the upper structure 3 based on the angular acceleration waveforms AW1, AW2, and AW3 and thus can suppress the sway of the hook or the suspended load hooked to the hook.

The preferred embodiments of the present disclosure have been described above. However, the invention of the present disclosure is not limited to the above-described embodiments. Various modifications, substitutions, and the like can be applied to the embodiments described above without departing from the scope of the present invention of the present disclosure. Each of the features described with reference to the above-described embodiments may be suitably combined provided that there is no technical inconsistency.

What is claimed is:

1. A crane comprising:
an upper structure configured to be capable of slewing;
an attachment provided on the upper structure configured to be capable of being luffed;
a hook that is hung and configured to be capable of being raised and lowered via the attachment; and
a controller including a memory and a processor coupled to the memory and configured to control a slew angular acceleration of the upper structure based on an angular acceleration waveform for suppressing sway of the hook in slew-stop control for automatically stopping slewing of the upper structure, wherein
the angular acceleration waveform includes
a first period in which an angular acceleration decreases from zero at a constant first change rate, and
a final period in which the angular acceleration increases to zero at a change rate after a predetermined period has elapsed after the first period, the change rate being opposite in sign to the first change rate.

2. The crane according to claim 1, wherein
the angular acceleration waveform includes
a second period continuous from the first period, in which the angular acceleration increases at a constant second change rate,
a third period continuous from the second period, in which the angular acceleration decreases at a third change rate equal to the first change rate,
a fourth period continuous from the third period, in which the angular acceleration increases at a fourth change rate opposite in sign to the third change rate,
a fifth period continuous from the fourth period, in which the angular acceleration decreases at a fifth change rate opposite in sign to the second change rate, and
the final period continuous from the fifth period.

3. The crane according to claim 1, wherein
the angular acceleration waveform includes
a second period continuous from the first period, in which the angular acceleration remains constant at a change rate of zero,
a third period continuous from the second period, in which the angular acceleration decreases at a third change rate equal to the first change rate,
a fourth period continuous from the third period, in which the angular acceleration increases at a fourth change rate opposite in sign to the third change rate,
a fifth period continuous from the fourth period, in which the angular acceleration remains constant at the change rate of zero, and
the final period continuous from the fifth period.

4. The crane according to claim 1, wherein
the angular acceleration waveform includes
a second period continuous from the first period, in which the angular acceleration remains constant at a change rate of zero, and
the final period continuous from the second period.

5. The crane according to claim 1, wherein
the processor is further configured to calculate a duration and a change rate for each period such that a phase point of the hook starts from an origin and returns to the origin through a plurality of arcs based on the change rate for each period of the angular acceleration waveform in a phase plane in which a horizontal axis represents a time derivative value a sway angle of the hook, and a vertical axis represents a value obtained by dividing a second order time derivative value of the sway angle by an angular frequency of the sway of the hook.

6. The crane according to claim 1, further comprising:
a slew motor configured to slew the upper structure, wherein
the processor is further configured to control the slew angular acceleration with the slew motor.

7. The crane according to claim 1, further comprising:
a slew sensor configured to detect the slew angular acceleration, wherein
the processor is further configured to acquire the slew angular acceleration from the slew sensor.

8. The crane according to claim 1, further comprising:
a sway sensor configured to detect a sway angle of the hook, wherein
the processor is further configured to acquire the sway angle from the sway sensor.

9. The crane according to claim 5, wherein
the processor is further configured to
determine whether the slew-stop control is to be performed,
generate the angular acceleration waveform, and
control the slew angular acceleration based on the angular acceleration waveform to stop the slewing of the upper structure.

10. The crane according to claim 9, wherein
the processor is further configured to perform the slew-stop control when an emergency stop button is pressed and/or when it is detected that an operator of the crane has suddenly released a slew control lever during the slewing of the upper structure.

11. The crane according to claim 9, wherein
the processor is further configured to output, to a proportional control valve, a control command that is based on the angular acceleration waveform, and
the proportional control valve is configured to control a pilot pressure of hydraulic fluid supplied from a pilot pump to a control valve of a control valve unit, based on the control command.
